(19) United States
(12) Patent Application Publication
(10) Pub. No.: US 2020/0366990 A1
(43) Pub. Date: Nov. 19, 2020

(54) MULTI-CHANNEL SOUND IMPLEMENTATION DEVICE USING OPEN-EAR HEADPHONES AND METHOD THEREFOR

(71) Applicants: Bonn-Hee Goo, Gyeonggi-do (KR); Chong-Suk Lee, Gyeonggi-do (KR); Woo-Jin Kim, Seoul (KR); Dong-Jun Kim, Seoul (KR)

(72) Inventor: Bonn-Hee Goo, Gyeonggi-do (KR)

(21) Appl. No.: 16/765,838

(22) PCT Filed: Dec. 6, 2018
(86) PCT No.: PCT/KR2018/015441

§ 371 Date: May 20, 2020

(30) Foreign Application Priority Data
Nov. 23, 2017 (KR) 10-2017-0157453

(51) Int. Cl. H04R 5/033; H04S 3/00; H04S 7/00

(52) U.S. Cl. CPC H04R 5/033; H04S 3/00; H04S 2400/09; H04S 2400/01; H04S 7/304

(57) ABSTRACT

A multi-channel sound implementation device comprising: a source data analysis unit for analyzing source data; a speaker system analysis unit; a headphone information analysis unit for analyzing information on at least one or more open-ear headphones for outputting sound in a state where the headphones are spaced apart from the ears of a user; an audio signal generation unit for, by using information on the audio signals, information on the speaker system and the information on the open-ear headphones, generating speaker audio signals having at least one channel, which may be reproduced in the speaker system, and generating headphone audio signals, which may be reproduced in the open-ear headphones; and a communication unit for transmitting the speaker audio signals to the speaker system, and transmitting the headphone audio signals to the respective open-ear headphones to which the headphone audio signals correspond.

### CROSS-REFERENCE TO RELATED APPLICATIONS

This application is a national phase entry under 35 U.S.C. § 371 of International Patent Application PCT/KR2018/015441, filed Dec. 6, 2018, designating the United States of America and published as International Patent Publication WO 2019/103584 A1 on May 31, 2019, which claims the benefit under Article 8 of the Patent Cooperation Treaty to Korean Patent Application Serial No. 10-2017-0157453 filed Nov. 23, 2017.

### TECHNICAL FIELD

This disclosure relates to a multi-channel sound implementation device using open-ear headphones, which output sounds without covering the ears of a user, and a method therefor.

### BACKGROUND

Earphones and headphones, which are conventional user devices for outputting sounds, are mostly configured to necessarily fully cover the ears of a user. Earphones are classified into kernel-type earphones, open-type earphones, and the like, and headphones are classified into open-back headphones, closed-back headphones, and the like. However, these earphones and headphones have characteristics in that they output sounds while necessarily covering the ears of a user.

However, outputting sounds in the state in which the ears of a user are covered has an effect of considerably diminishing or blocking external sounds, which results in problems in which it is difficult to talk with other people and in which it is difficult to sense surrounding dangers.

When sounds are output in the state in which the ears are uncovered in order to solve the above-mentioned problems, the sounds are also delivered to other people, which disturbs them, and a sound quality degradation problem may be caused because the sounds are not clearly delivered. Therefore, technology for overcoming these problems is required.

Also, audio player systems, which have changed from mono systems to stereo systems, have recently expanded to multi-channel sound systems, such as 2.1-channel systems, 5.1-channel systems, and the like, thereby producing a 3D sound effect and improving a sense of space.

Generally, a multi-channel sound system includes front channels by default and optionally includes a side surround channel, a rear surround channel, a top surround channel, a front woofer channel, a rear woofer channel, and the like, thereby being configured with a combination of such channels. As the number of channels increases, there is an advantage in that sounds having a better 3D effect can be provided to listeners, but it is expensive to configure many channels. Further, there is a problem in that it is difficult to provide sounds optimized for the positions of multiple listeners because the channels are configured using speakers.

The above-described information about the related art has been retained by the inventors for the purpose of developing embodiments of the present disclosure or was obtained during the process of developing embodiments of the present disclosure. Also, it should be appreciated that this information did not necessarily belong to the public domain before the patent filing date of the present disclosure.

Meanwhile, Korean Patent No. 10-1567521, titled “Headphone,” discloses headphones configured to deliberately increase the volume of the space in which a sound is formed, thereby preventing reverberation and booming effects and minimizing the inflow of ambient noise into the space in which the sound is formed.

### BRIEF SUMMARY

An object of the present disclosure is to provide a multi-channel sound implementation device using open-ear headphones, which output sounds in the state in which the ears of a user are uncovered, and a method therefor.

Another object of the present disclosure is to provide a multi-channel sound implementation device configured to expand a multi-channel sound system by assigning additional channels to open-ear headphones and a method therefor.

A further object of the present disclosure is to provide a multi-channel sound implementation device configured to correct a headphone channel and a speaker channel and mix the same and a method therefor.

Yet another object of the present disclosure is to provide a multi-channel sound implementation device configured to perform sound segmentation and correction in order to improve a 3D effect for each of multiple sets of headphones and a method therefor.

An embodiment of the present disclosure provides a device for implementing a multi-channel sound, the device including a source data analysis unit for analyzing source data in order to detect audio signal information of one or more channels generatable from the source data; a speaker system analysis unit for analyzing information about a speaker system; a headphone information analysis unit for analyzing information about one or more sets of open-ear headphones that output sounds in the state in which ears of a user are uncovered by being spaced apart from the ears of the user; an audio signal generation unit for generating speaker audio signals having one or more channels to be reproduced in the speaker system and headphone audio signals to be reproduced in the open-ear headphones using the audio signal information, the information about the speaker system, and the information about the open-ear headphones; and a communication unit for transmitting the speaker audio signals to the speaker system and transmitting the headphone audio signals to the respective sets of open-ear headphones corresponding thereto.

The information about the speaker system may include at least one of the number of speakers included in the speaker system, location information pertaining to the speakers, and available channel information pertaining to the speakers.

The information about the open-ear headphones may include the number of sets of open-ear headphones and headphone location information corresponding to each of the sets of open-ear headphones, and the audio signal generation unit may generate the headphone audio signals corresponding to the headphone location information.

The device may further include an audio signal correction unit for correcting the headphone audio signals and the speaker audio signals using the headphone location information.

The audio signal correction unit may correct at least one of level information, delay information, channel information, equalization information, and output direction information for each of the headphone audio signals and the speaker audio signals.

The information about the open-ear headphones may include head-tracking information corresponding to each of the sets of open-ear headphones, and the audio signal correction unit may correct the headphone audio signals depending on the orientation of each of the sets of open-ear headphones using the head-tracking information.

The device may further include a video signal correction unit for correcting delay information of a video signal corresponding to a video channel in consideration of the headphone audio signals and the speaker audio signals when the video channel is included in the source data.

The audio signal correction unit may correct the headphone audio signals and the speaker audio signals using the headphone location information so as to provide a stereophonic sound obtainable when the open-ear headphones are located at a preset virtual point.

The audio signal correction unit may correct the headphone audio signals and the speaker audio signals using the headphone location information so as to provide a stereophonic sound corresponding to the location of each of the sets of open-ear headphones.

When the operation of the open-ear headphones is stopped, the audio signal generation unit may again generate the speaker audio signals for outputting sounds only through the speaker system.

Another embodiment of the present disclosure provides a method for implementing a multi-channel sound, the method including analyzing source data in order to detect audio signal information of one or more channels generatable from the source data; analyzing information about a speaker system; analyzing information about one or more sets of open-ear headphones that output sounds in the state in which ears of a user are uncovered by being spaced apart from the ears of the user; generating speaker audio signals having one or more channels to be reproduced in the speaker system and headphone audio signals to be reproduced in the open-ear headphones using the audio signal information, the information about the speaker system, and the information about the open-ear headphones; and transmitting the speaker audio signals to the speaker system and transmitting the headphone audio signals to the respective sets of open-ear headphones corresponding thereto.

The information about the speaker system may include at least one of the number of speakers included in the speaker system, location information pertaining to the speakers, and available channel information pertaining to the speakers.

The information about the open-ear headphones may include the number of sets of open-ear headphones and headphone location information corresponding to each of the sets of open-ear headphones, and generating the audio signals may be configured to generate the headphone audio signals corresponding to the headphone location information.

The method may further include an audio signal correction unit for correcting the headphone audio signals and the speaker audio signals using the headphone location information.

Correcting the audio signals may include correcting at least one of level information, delay information, channel information, equalization information, and output direction information for each of the headphone audio signals and the speaker audio signals.

The information about the open-ear headphones may include head-tracking information corresponding to each of the sets of open-ear headphones, and correcting the audio signals may be configured to correct the headphone audio signals depending on the orientation of each of the sets of open-ear headphones using the head-tracking information.

The method may further include correcting delay information of a video signal corresponding to a video channel in consideration of the headphone audio signals and the speaker audio signals when the video channel is included in the source data.

Correcting the audio signals may include correcting the headphone audio signals and the speaker audio signals using the headphone location information so as to provide a stereophonic sound obtainable when the open-ear headphones are located at a preset virtual point.

Correcting the audio signals may include correcting the headphone audio signals and the speaker audio signals using the headphone location information so as to provide a stereophonic sound corresponding to the location of each of the sets of open-ear headphones.

Generating the audio signals may include again generating the speaker audio signals for outputting sounds only through the speaker system when the operation of the open-ear headphones is stopped.

According to the present disclosure, a multi-channel sound system may be easily constructed through a multi-channel sound implementation device using open-ear headphones, which output sounds in the state in which ears are uncovered, and a method therefor.

Also, through a multi-channel sound implementation device using open-ear headphones and a method therefor, the present disclosure expands a multi-channel sound system by assigning additional channels to the open-ear headphones, thereby expanding the channels of an existing sound system configured with multi-channel speakers.

Also, through a multi-channel sound implementation device using open-ear headphones and a method therefor, the present disclosure corrects a headphone channel and a speaker channel and mixes the same, whereby the sounds of the headphone channel and the speaker channel may be harmonized with each other without delay or distortion, and a better 3D effect may be provided.

Also, through a multi-channel sound implementation device using open-ear headphones and a method therefor, the present disclosure performs sound segmentation and correction in order to improve a 3D effect for each of multiple sets of open-ear headphones, thereby providing a 3D effect optimized for the position of a listener or providing a 3D effect at a specific position in a listening area regardless of the actual position of a listener.

### BRIEF DESCRIPTION OF THE DRAWINGS

FIG. 1 is a view illustrating the configuration of a sound reproduction system using open-ear headphones according to an embodiment of the present disclosure;

FIG. 2 is a block diagram illustrating an example of the open-ear headphones illustrated in FIG. 1;

FIGS. 3 and 4 are views illustrating open-ear headphones according to an embodiment of the present disclosure and the appearance of wearing the open-ear headphones;

FIG. 5 is a view illustrating an example of wearing the right-side part of open-ear headphones according to an embodiment of the present disclosure;

FIGS. 6 and 7 are views illustrating an example of the right-side part of open-ear headphones according to an embodiment of the present disclosure;

FIG. 8 is a flowchart illustrating a method for reproducing sounds using open-ear headphones according to an embodiment of the present disclosure;

FIG. 9 is a view illustrating the appearance of wearing open-ear headphones according to an embodiment of the present disclosure;

FIG. 10 is a view illustrating an example of wearing the right-side part of open-ear headphones according to an embodiment of the present disclosure

FIG. 11 is a view illustrating a multi-channel sound implementation system using open-ear headphones according to an embodiment of the present disclosure;

FIG. 12 is a view illustrating a multi-channel sound implementation device using open-ear headphones according to an embodiment of the present disclosure;

FIGS. 13 to 17 are views illustrating examples of configuring a multi-channel sound implementation system using open-ear headphones according to an embodiment of the present disclosure; and

FIG. 18 is a flowchart illustrating a method for implementing a multi-channel sound using open-ear headphones according to an embodiment of the present disclosure.

### DETAILED DESCRIPTION

Because the present disclosure may be variously changed and may have various embodiments, specific embodiments will be described in detail below with reference to the attached drawings. The effects and features of embodiments of the present disclosure and methods of achieving them will be apparent from the following exemplary embodiments, which will be described in more detail with reference to the accompanying drawings. Repeated descriptions and descriptions of known functions and configurations that have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

However, the present disclosure is not limited to the embodiments to be described below, and all or some of the embodiments may be selectively combined and configured, and thus the embodiments may be modified in various ways. It will be understood that, although the terms “first,” “second,” etc., may be used herein to describe various elements, these elements are not intended to be limited by these terms. These terms are only used to distinguish one element from another element. Also, a singular expression includes a plural expression unless a description to the contrary is specifically pointed out in context. Also, it should be understood that terms such as “include” or “have” are merely intended to indicate that features, components, or combinations thereof are present, and are not intended to exclude the possibility that one or more other features, components, or combinations thereof will be present or added.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

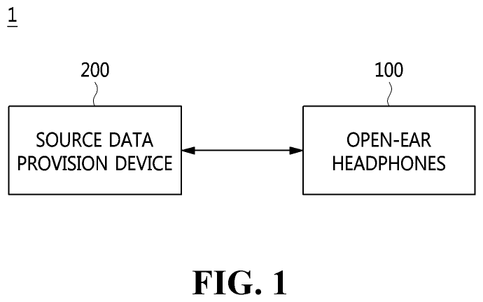

FIG. 1 is a view illustrating the configuration of a sound reproduction system 1 using open-ear headphones according to an embodiment of the present disclosure.

Referring to FIG. 1, open-ear headphones 100 are interconnected with a source data provision device 200 in the sound reproduction system 1 using the open-ear headphones according to an embodiment of the present disclosure. Here, the open-ear headphones 100 and the source data provision device 200 may be connected with each other in a wired or wireless manner, and technology such as Bluetooth or the like may be used for wireless connection.

The open-ear headphones 100 according to an embodiment of the present disclosure are configured to receive source data from the source data provision device 200, to extract one or more audio channels from the source data, to generate output audio signals from the audio channels, and to output the output audio signals using speakers spaced apart from the ears of a user.

That is, even though the open-ear headphones 100 are worn, because the ears of the user are completely open, the user is able to fully hear external sounds. When a sound is reproduced through the open-ear headphones 100, the user may listen to the output sound with an effect as if external sounds were not heard because of a masking effect. Also, even while a sound is being reproduced, the user is able to hear a sound that the user wants to hear, among external sounds, through a cocktail-party effect.

That is, using the open-ear headphones of the present disclosure, which are designed such that a sound is audible only to a user in the state in which the ears of the user are uncovered, the user may sense dangers because the user is able to hear external sounds while listening to the desired sound, and surrounding people may be prevented from hearing unwanted sound. Also, the user does not have to take off the headphones when playing or stopping a sound because the ears are uncovered, and the user may be prevented from feeling stuffy or uncomfortable, which may be caused by covering the ears. Also, auditory difficulties resulting from high sound pressure and long-term use of the headphones may be prevented. Also, power consumption may be minimized by separately outputting a low-pitched sound and a high-pitched sound. Also, in combination with another sound system, a multi-channel sound system may be constructed.

When a multi-channel sound system is constructed in combination with an additional sound system, the surround sounds of the additional sound system and the binaural sounds of the open-ear headphones 100 of the present disclosure are merged, whereby immersive sounds having a better 3D effect and better realism may be provided.

Here, the source data is source data for the video or sound source to be output, and the source data includes audio data.

Particularly, the open-ear headphones 100 are not limited as to the shape thereof. The headphones may have a form fastened on the top of the head of a user, such as general over-the-head headphones, or a form fastened behind the head, but may also have the form of a mask, the form of glasses, the form of smart glasses, or the like. That is, the form is satisfactory as long as the headphones are configured to enable the ears of a user to be open. Particularly, the open-ear headphones 100 may be divided into two units, that is, left and right units, such that they are mounted on the glasses of a user or such that they are separately attached by encircling the auricle or the rim of the external ear of the user.

When a single source data provision device 200 is connected with multiple sets of open-ear headphones 100, the respective sets of headphones may output different sounds. For example, sounds for providing a 3D effect that matches the locations of the respective sets of headphones may be output.

Also, sounds having a 3D effect may be output in consideration of the positional relationship between the source data provision device 200 and the open-ear headphones 100. For example, when the user is located in front of, on the right side of, or on the left side of the source data provision device 200, different sounds may be provided for the respective cases, whereby the user may detect the positional relationship with the source data provision device 200 based only on the 3D effect of the output sound. Accordingly, the user may listen to a sound having a better 3D effect, and may be immersed in content. In contrast, sounds for providing a 3D effect that matches a virtual location that is fixed regardless of the location of the open-ear headphones 100 may be output.

Also, the multiple sets of open-ear headphones 100 are directly or indirectly connected with each other, thereby providing a wireless transmission/reception function as in a radio transceiver or a teleconferencing phone.

The source data provision device 200 is a device for providing the source data of the sound source to be reproduced in the open-ear headphones 100. For example, the source data provision device 200 includes a CD player, an MP3 player, a PC, a smartphone, and the like.

Here, the source data provision device 200 may perform control related to sound reproduction simultaneously with provision of the source data. For example, control such as starting, stopping, and pausing the replay of the source data, playing the next song, playing the previous song, volume control, and the like may be performed.

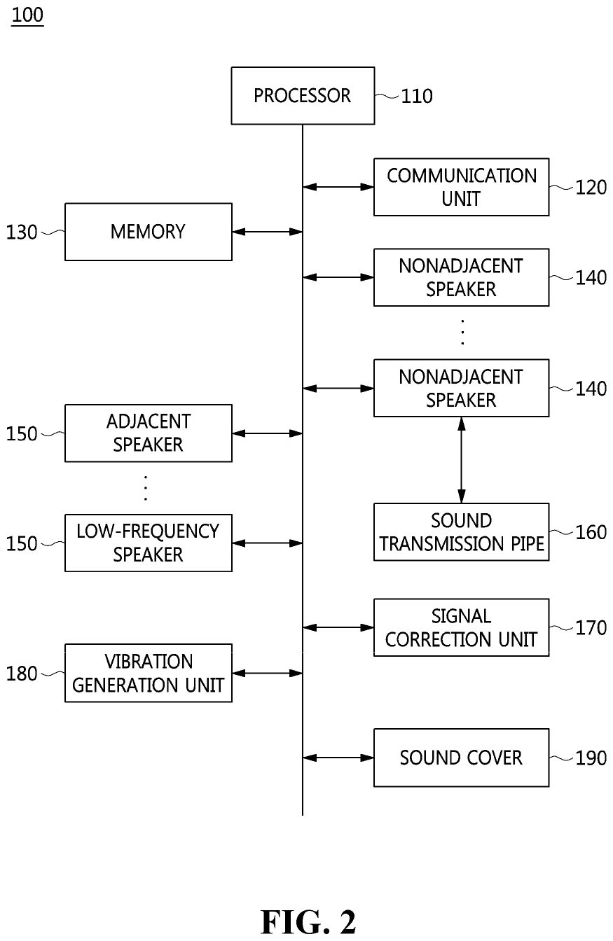

FIG. 2 is a block diagram illustrating an example of the open-ear headphones 100 illustrated in FIG. 1.

Referring to FIG. 2, the open-ear headphones 100 according to an embodiment of the present disclosure include a processor 110, a communication unit 120, memory 130, nonadjacent speakers 140, adjacent speakers 150, sound transmission pipes 160, a signal correction unit 170, a vibration generation unit 180, a sound cover 190, a microphone, and the like.

Specifically, the processor 110 is a kind of central processing unit, and controls the overall function of the open-ear headphones 100. That is, the processor 110 may generate output audio signals, and may provide various functions by controlling the nonadjacent speakers 140, the adjacent speakers 150, the sound transmission pipes 160, the signal correction unit 170, the vibration generation unit 180, and the like.

The processor 110 extracts one or more audio channels from the source data received from the source data provision device (200 in FIG. 1) and generates output audio signals from the audio channels. Here, the output audio signals may be signals for outputting immersive sounds.

Here, the processor 110 may generate high-frequency audio signals, corresponding to a preset first frequency band, and low-frequency audio signals, corresponding to a preset second frequency band, as the output audio signals. For example, the first frequency band may range from 200 Hz to 20 kHz, and the second frequency band may range from 20 Hz to 200 Hz. Here, the high-frequency audio signals and the low-frequency audio signals may be separated using a crossover or filters. That is, high-frequency audio signals may be generated by rolling off low frequencies using a high-pass filter (HPF), and low-frequency audio signals may be generated by rolling off high frequencies using a low-pass filter (LPF). Here, the high-pass filter and the low-pass filter may be set by a user. Also, the crossover frequency or the filter frequency may be adjusted depending on the surround sound format.

Here, the processor 110 may generate the audio signals to be output from the nonadjacent speakers 140 and the audio signals to be output from the adjacent speakers 150. For example, the audio signals to be output from the nonadjacent speakers 140 may be generated by assigning the high-frequency audio signals, and the audio signals to be output from the adjacent speakers 150 may be generated by assigning the low-frequency audio signals, but the present disclosure is not limited thereto. That is, the audio signals to be assigned to the respective speakers may be generated using any of various combinations.

Here, when the left and right directions of the open-ear headphones 100 are reversed, the processor 110 may reverse the left and right channels of the output audio signals. For example, a user may wear the open-ear headphones 100 around his or her neck, like a necklace, in the state in which the left and right directions thereof are reversed. In this case, the left and right directions of the speakers are reversed, and in response thereto, the left and right channels of the output audio signals are forcibly reversed, whereby the left and right directions of the sound to which the user is listening may be maintained. In this case, the open-ear headphones 100 may function as speakers.

Here, the processor 110 may generate an output vibration signal from at least one of the source data and the sound input from the microphone. Here, the output vibration signal may be generated from vibration data included in the source data, but may be generated from audio data even when no vibration data is included in the source data.

For example, the ambience level of the audio source data is sensed, and the difference between the ambience level and the maximum level thereof is calculated. Then, when the difference reaches a specific percentage level, a vibration corresponding thereto is generated, whereby an output vibration signal may be generated. Here, a transient state may be sensed, and a vibration may be generated based thereon, or an output vibration signal may be generated so as to generate a vibration when the level of an audio signal is equal to or higher than a specific level.

Also, an output vibration signal may be generated so as to generate a vibration when the level of the ambient sound input through the microphone is equal to or higher than a specific level. Accordingly, a surrounding danger may be announced using vibration even while a sound is being reproduced.

Here, the processor 110 may generate output audio signals from which noise is cancelled using the ambient sound that is input through the microphone.

Here, the processor 110 may generate output audio signals such that the size of space is realized by adjusting the time taken for an indirect sound to reach the space using early-reflection parameters so as to improve a sense of space of the output sounds. Also, using both a Head-Related Transfer Function (HRTF) and a delay parameter, immersive sounds that provide a strong sense of space may be provided.

Here, the processor 110 may generate output audio signals for navigation notification, and may generate binaural output audio signals having a 3D effect that matches the direction indicated by the navigation notification. For example, when the navigation notification is left-turn notification, binaural output audio signals may be generated so as to have a 3D effect that seems as if the sound were heard from the left side of the user. Similarly, right-turn notification, floor bump notification, and speed camera notification may have 3D effects that seem as if the sound were heard from the right side, from the bottom, and from the top, respectively.

The communication unit 120 provides communication interfaces required for sending transmission/reception signals between the open-ear headphones 100 and the source data provision device (200 in FIG. 1).

Here, the communication unit 120 may be a device including hardware and software required for transmitting and receiving signals, such as control signals or data signals, through wired/wireless connection with other network devices. For example, the communication unit 120 may communicate with the source data provision device (200 in FIG. 1) through Bluetooth technology or Wi-Fi technology, or may perform pairing with the source data provision device (200 in FIG. 1) through NFC technology. Also, it may operate in conjunction with other open-ear headphone devices 100 through Bluetooth technology or Wi-Fi technology.

The memory 130 performs the function of temporarily or permanently storing the data processed by the processor 110. Here, the memory 130 may include magnetic storage media or flash storage media, but the scope of the present disclosure is not limited thereto.

The nonadjacent speakers 140 output audio signals through the sound transmission pipes 160. That is, the directivity of the output sounds may be improved through the sound transmission pipes 160. Here, the nonadjacent speakers 140 may include a directional sound output unit. That is, the high-frequency audio signals are output so as to have directivity, whereby the sounds output to a user may be correctly transmitted. Also, in addition to improvement of the directivity of the output sounds through the sound transmission pipes 160, directivity may be imparted to the output sounds using the directional sound output unit. Here, the directional sound output unit may be a super-directional speaker having an ultrasonic circuit.

Here, the nonadjacent speakers 140 may use a high-quality full-range driver in order to ensure maximum sound quality. Also, an acoustic driver may be used exclusively, or it may be used along with the adjacent speakers 150, whereby sounds of the entire frequency band may be output.

Here, the nonadjacent speakers 140 may output a sound of reading the notification from the headphones themselves or a notification from the device connected therewith in a voice.

The adjacent speakers 150 output audio signals without passing them through the sound transmission pipes 160. Here, the adjacent speakers 150 reproduce not only a low frequency but also a high frequency, thereby outputting full-range audio.

Here, the adjacent speakers 150 may be formed of bone conduction elements or exciter elements. Accordingly, a problem in which it is difficult for a low-frequency sound to be clearly transmitted only to a user due to the characteristics thereof, such as low directivity, high diffraction, and high attenuation during propagation, may be solved. Also, without adjustment for raising the amplification output, a sound at the desired level may be output. Also, without adding a separate EQ circuit, implementation may be possible.

Here, the adjacent speakers 150 may be mounted on any part of the open-ear headphones 100, and may reproduce the sensation of a low-frequency sound by functioning as a subwoofer. Also, using the entire body of the open-ear headphones 100 or a part thereof as a vibration plate, the output of a low-pitched sound may be reinforced. In other words, the adjacent speakers 150 are not limited as to the locations thereof.

Here, the adjacent speakers 150 may output sounds in the state in which they adhere to the body of the user. That is, the adjacent speakers 150 may naturally transmit a low-frequency sound to the inner ear of a user through the skin of the head of the user using a large wavelength. Also, a more dramatic listening environment may be provided by vibrating the scalp using a large wavelength.

Here, the adjacent speakers 150 may perform a Low-Frequency Effect (LFE) function.

Here, the adjacent speakers 150 may output a sound of reading the notification from the headphones themselves or a notification of the device connected therewith in a voice.

The sound transmission pipes 160 are connected with the nonadjacent speakers, thereby transmitting the sounds output from the nonadjacent speakers towards the ears of the user such that the sounds have directivity. That is, the sound transmission pipes 160 have the effect of aggregating sound energy in one direction. Also, while the sounds output from the nonadjacent speakers pass through the streamlined sound transmission pipes, directivity is imparted thereto, whereby the sounds having directivity may be transmitted to the ears of the user. Here, the sound transmission pipes may have streamlined shapes. As the result, sound energy is efficiently transmitted, whereby there is an advantage in that output loss is low.

Here, the sound transmission pipe may be configured with multiple sound transmission pipes. That is, a sound may be transmitted using a bundle of multiple sound transmission pipes having a small diameter, rather than a single sound transmission pipe having a large diameter. Using the multiple sound transmission pipes having a small diameter, a decrease in directivity resulting from diffraction of the transmitted sound is prevented, and the effect whereby a sound escapes out of the ear of the user may be reduced.

Here, the respective sound transmission pipes may be configured to transmit sounds separated based on respective frequency bands.

Here, the sound transmission pipes have a spiral structure, thereby improving directivity. Also, the sound transmission pipes may pass a specific frequency by including a filter therein. Particularly, the sound transmission pipes may have the inverse shape of the auricle, thereby providing a structure that enables sounds to naturally enter along the outer ear canal. Also, the sound transmission pipes may function to concentrate sounds and transmit the same to the outer ear canal in place of the auricle, and function to prevent the sound output from the speaker from being transmitted to the outside of the auricle of the user.

As described above, as the frequency of a sound is higher, the directivity thereof increases and diffraction thereof decreases. Accordingly, a high-frequency audio signal and a low-frequency audio signal having different degrees of directivity may be processed separately.

Here, the sound transmission pipes 160 may include radiation grilles for adjusting the direction in which sounds finally radiate from the pipe end near the ear of the user. The radiation grilles function to adjust the directional output sounds so as to reach the ear of the user in consideration of the fact that each user has a different body structure. Here, the tilt angle may be 45 degrees. Here, the user may adjust the direction of the radiation grilles. The grilles may be adjusted through a method using a slide bar, a wheel, or the like. Particularly, the radiation grilles have a structure for minimizing sound diffraction, and may have a structure that tilts so as to match the orientation of the ear.

Here, the sound transmission pipes 160 may transmit sounds that are output so as to run from the outside of the ear of the user to the inside of the ear of the user.

Here, the sound transmission pipes 160 include filters therein, thereby passing and transmitting only a preset frequency.

Here, the sound transmission pipes 160 may include vibration-absorbing material for suppressing vibrations. Here, the vibration-absorbing material may wrap around the outer wall of the sound transmission pipes, or may be disposed so as to come into contact with some of the surfaces thereof.

The signal correction unit 170 may correct the output audio signals by generating correction parameters using sound transmission pipe parameters. This is because the waveform or volume of the output sounds changes and the transmission time is delayed while the output sounds pass through the sound transmission pipe.

Here, the sound transmission pipe parameters may include information corresponding to at least one of the material, the length, the size, and the shape of the sound transmission pipes, and the correction parameters may include at least one of equalizer adjustment information, delay adjustment information, and level adjustment information pertaining to the output audio signals. That is, correction suitable for each of the output audio signals is performed in consideration of the characteristics of each of the sound transmission pipes, whereby a user may listen to a sound without distortion.

The vibration generation unit 180 outputs an output vibration signal, thereby generating a vibration.

Here, the vibration generation unit 180 may adjust the strength of the vibration to be output. Also, the strength of the vibration may be adjusted in response to user input. Also, the strength of vibration according to the source data and the strength of vibration for notification may be set differently. Adjusting the strength of vibration includes the case in which a vibration function is not used at all. Accordingly, the vibration function may be set to use vibration only for notifications.

For example, the vibration generation unit 180 may generate a vibration for the purpose of supplementing a low-frequency sound in the output audio signals. Also, vibration may be generated for the purpose of providing a notification when a danger is sensed from ambient sounds. Also, a vibration may be generated for the purpose of providing notification of the source data provision device 200. That is, when the source data provision device 200 is a smartphone, interactive vibration may be generated for call notification, message notification, or application notification.

The sound cover 190 covers at least a part of the ear of a user, thereby functioning to concentrate the sounds output from the speakers towards the ear of the user. The user may listen to a sound without the sound cover 190 because the open-ear headphones 100 output sounds with directivity, but when the sound cover 190 is additionally used, it concentrates sounds, whereby the user may listen to clearer sounds having an improved sense of space. Also, the outward transmission of the output sound may be reduced.

Here, the sound cover 190 may have a detachable structure.

Here, the sound cover 190 may have a structure that can be manipulated to a state of covering the ear of the user or a state of not covering the ear of the user in a folding or sliding manner.

The microphone receives ambient sounds. Here, the microphone may comprise multiple microphones.

Here, the sounds received by the microphone may be used for providing a noise-cancelling function, for providing a danger notification function based on ambient sounds, or for providing a voice recognition control function or the like by recognizing the voice of a user. The noise-cancelling function may be performed by differentiating front and back/left and right/up and down.

Here, binaural sounds may be received using two or more omnidirectional microphones.

Here, the microphone may function as a sound input device for a call by being connected with the terminal of a user. Also, using two or more microphones, ambient noise, other than the voice of the user, may be cancelled.

Accordingly, a directional sound is output in the state in which the ears of a user are uncovered, whereby the user may clearly listen to the output sound while hearing ambient sounds. Also, the output sound is prevented from being heard by other people, whereby sound-induced damage may be reduced. Also, hearing impairment arising from sound pressure caused by the long-term use of the headphones may be prevented.

The open-ear headphones 100 according to an embodiment of the present disclosure may include a sensor unit.

Here, the sensor unit may include an optical sensor, and may sense ambient brightness through the optical sensor, thereby recognizing whether it is day or night. When the current time is recognized as the nighttime, the function of reproducing audio at a dimming level previously set by a user may be performed.

Here, the sensor unit may include a GPS sensor, thereby determining the current position thereof. Also, the position may be recorded, and location-based service may be provided.

Here, the sensor unit may include an ultrasonic sensor, thereby determining whether or not the headphones are being worn. Also, bio-signals, such as the heart rate of a user, may be monitored.

Here, the sensor unit may include an acceleration sensor or a gyroscope sensor, thereby tracking the movement of the head of a user. Using the tracked movement of the head of the user, the function of controlling the headphones based on gestures may be provided. For example, specific instructions are assigned to motions, such as nodding the head, nodding the head twice, turning the head from the left side to the right side for about one second, quickly turning the head from the left side to the right side, leaning the head from the left side to the right side, leaning the head from the left side to the right side for a moment, and the like, whereby control functions may be provided. Particularly, the movement of the user is learned, whereby the accuracy of recognition of the gesture from the movement of the corresponding user may be improved.

Also, when a multi-channel sound system is constructed by being connected with another speaker system, the sensor unit may adjust all of panning values for surround sounds depending on the location of the head of the user.

Here, the sensor unit determines whether the user is wearing the headphones using any of various sensors, and enters a sleep mode or a standby mode when the user is determined not to be wearing the headphones, thereby optimizing power consumption. Also, the size of the head of the user who wears the headphones is recognized using any of various sensors, and the headphones are prevented from being used by another person whose head has a different size from the head of the registered user, whereby a security function may be provided.

The open-ear headphones 100 according to an embodiment of the present disclosure may include a glasses holder, and through this, the glasses or sunglasses of the user may be fixed. Accordingly, the user may put on the headphones in the state in which the user is wearing glasses or sunglasses. Here, the glasses holder may be configured such that a part of the glasses or sunglasses of the user is inserted in the headphones.

The open-ear headphone 100 according to an embodiment of the present disclosure may include a manipulation unit, and the manipulation unit may include an input unit capable of recognizing at least one of a touch, a slide and a click by a user. The user may control the open-ear headphones 100 through a touch, a slide, a click, or the like using the manipulation unit, and may further control the source data provision device (200 in FIG. 1) connected with the headphones or the user terminal connected with the headphones.

The open-ear headphones 100 according to an embodiment of the present disclosure may include a foldable part, and the foldable part may include a hinge that enables the body of the headphones to be folded in order to easily carry the open-ear headphones 100. Here, multiple foldable parts may be included.

The open-ear headphones 100 according to an embodiment of the present disclosure may include a battery, and this battery may be capable of being charged. The charging method may use at least one of a wired method, a wireless method, and a wired/wireless method. Also, the battery may be configured so as to be replaceable in a detachable manner.

The open-ear headphones 100 according to an embodiment of the present disclosure include a band part, and the band may have a structure so as to be fastened on the top of the head of a user, to be fastened behind the head of the user, to be fastened by wrapping around the neck of the user, or the like. The location at which the headphones are fastened may be adjustable in a single product, but the location may be determined to be fixed to one location in each product. Here, the band part may include one or more protrusions formed thereon in order to realize friction with the hair of the user or the scalp of the user, thereby preventing the band part from slipping down. Also, the band part may comprise multiple band parts in order to increase frictional force. The band part may include a length adjustment part, which provides the function of adjusting the length of the open-ear headphones 100 because the size suitable for each user is different. Here, the length adjustment part may be configured to increase or decrease the length using a slide method.

The open-ear headphones 100 according to an embodiment of the present disclosure include a module-mounting part, and one or more module-mounting parts may be placed in various locations, such as the front, the side, the rear and the like of the headphones. The module mountable on the module-mounting part may include a camera module, a lighting module, a First-Person-View (FPV) module, an extension battery module, and the like.

Here, when the FPV module is installed and used, information providing a 3D effect may be provided along with binaural sounds. For example, navigation image information may be output through the PFV module, and a stereophonic notification sound corresponding to the navigation notification may be provided through the above-mentioned binaural sounds.

Here, a stereoscopic image or a panoramic image may be captured by installing multiple camera modules.

The open-ear headphones 100 according to an embodiment of the present disclosure include an infrared signal generation unit, thereby functioning as a remote controller of an AV device using an application connected with the headphones or the manipulation button of the headphones.

Here, the infrared signal generation unit may be placed on the front side of the headphones.

The open-ear headphones 100 according to an embodiment of the present disclosure include a solar-energy-charging unit, thereby charging a battery embedded in the headphones. One or more solar-energy-charging units may be disposed in various locations, such as the rear, the side, and the like of the headphones. Also, the solar-energy-charging unit may include a solar thermal panel, a solar photovoltaic panel, and the like.

The open-ear headphones 100 according to an embodiment of the present disclosure include a front-directional speaker, and a sound for providing information to the person in front may be output through the front-directional speaker.

Here, a simultaneous interpretation function may be provided using the front-directional speaker along with the microphone.

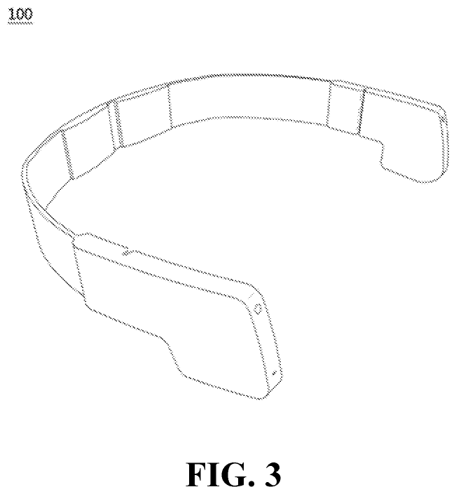

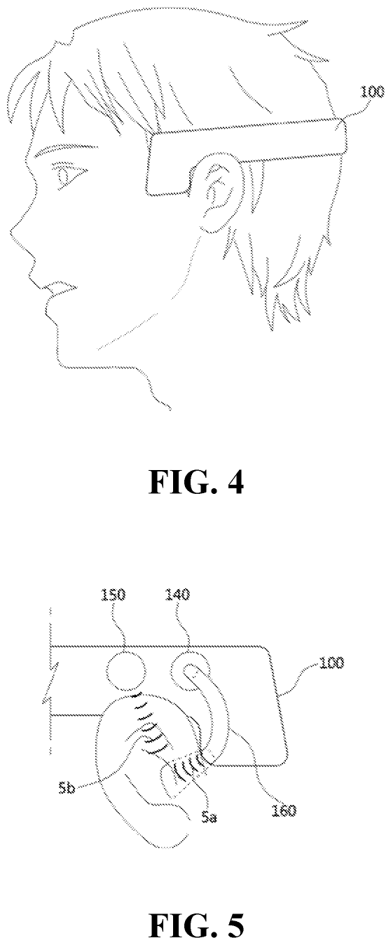

FIGS. 3 and 4 are views illustrating open-ear headphones 100 according to an embodiment of the present disclosure and the appearance of wearing the open-ear headphones.

Referring to FIGS. 3 and 4, the open-ear headphones 100 according to an embodiment of the present disclosure may have the form of a headband wrapped around the back of the head of a user. Also, speakers are placed at the end thereof, thereby outputting sounds without covering the ears of the user.

Also, unlike what is illustrated in FIGS. 3 and 4, the open-ear headphones 100 may have the form of a headband wrapped around the top of the head of the user, like general headphones.

Also, although the open-ear headphones 100 are illustrated as not covering the ear of a user at all in FIG. 4, the open-ear headphones 100 may cover a part of the ear of the user depending on the configuration thereof, but may nevertheless be spaced apart from the ear of the user.

FIG. 5 is a view illustrating an example of wearing the right-side part of open-ear headphones 100 according to an embodiment of the present disclosure.

Referring to FIG. 5, the open-ear headphones 100 do not cover the ears of a user when the user wears the open-ear headphones.

Because the degree of directivity, the degree of diffraction, and the degree of attenuation of a sound during propagation vary depending on the frequency of the sound, a low-frequency audio signal and a high-frequency audio signal may be processed separately.

The nonadjacent speaker 140 outputs an audio signal (particularly, a high-frequency audio signal) generated from source data, and the output sound 5a is transmitted to the ear of the user through the sound transmission pipe 160. Here, the sound transmission pipe 160 has a spiral shape, thereby improving the directivity of the transmitted sound. Also, the nonadjacent speaker 140 may output a directional sound using a directional speaker unit.

The adjacent speaker 150 outputs an audio signal 5b (particularly, a low-frequency audio signal) generated from the source data. Here, the adjacent speaker 150 may output the audio signal using a bone conduction element or an exciter element. By using the bone conduction element or the exciter element, directivity and attenuation problems may be solved.

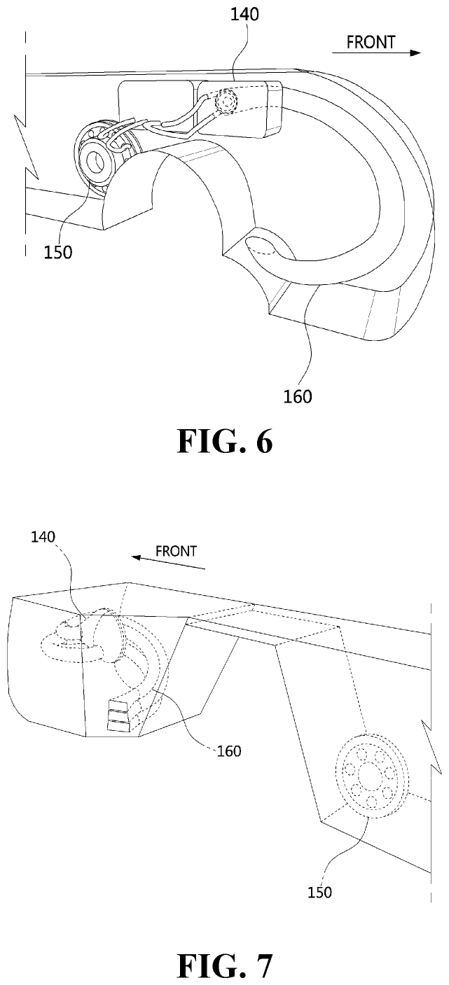

FIGS. 6 and 7 are views illustrating an example of the internal structure of the right-side part of open-ear headphones 100 according to an embodiment of the present disclosure.

Specifically, FIGS. 6 and 7 are perspective views illustrating the internal structure of the right-side part of open-ear headphones 100 according to an embodiment of the present disclosure. Also, the right side of the drawing corresponds to the front direction (the forward direction of a user) in FIG. 6, and the upper left corner of the drawing corresponds to the front direction (the forward direction of the user) in FIG. 7.

Referring to FIGS. 6 and 7, the open-ear headphones 100 according to an embodiment of the present disclosure are configured such that the sounds output from the nonadjacent speaker 140 are transmitted towards the ear of the user through the sound transmission pipe 160. Also, the adjacent speaker 150 may output sounds using a bone conduction element or an exciter element, rather than through the ear of the user.

Here, the nonadjacent speaker 140 may output directional sounds using a directional sound output unit.

Here, the sound transmission pipe 160 has a spiral structure, thereby improving the directivity of the transmitted sound.

Here, a number of sound transmission pipes 160 equal to the number of nonadjacent speakers 140 may be provided, as shown in FIG. 6, but a number of sound transmission pipes 160 more than that may be provided, as shown in FIG. 7.

Here, when multiple sound transmission pipes 160 are provided, the respective sound transmission pipes may output sounds that are separated based on respective frequency bands. The respective sound transmission pipes may output sounds for realizing an immersive sound. Accordingly, a sense of space and a 3D effect may be provided by reproducing different sounds through the respective sound transmission pipes. Particularly, when many sound transmission pipes having a small size are used, there is a benefit from the aspect of directivity, compared to when a small number of sound transmission pipes having a large size is used.

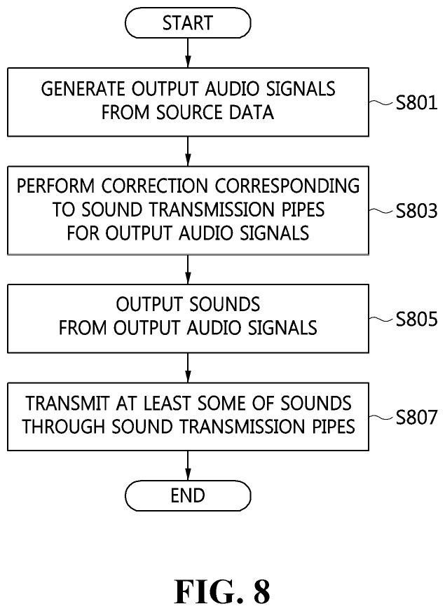

FIG. 8 is a flowchart illustrating a method for reproducing a sound using open-ear headphones according to an embodiment of the present disclosure.

Referring to FIG. 8, in the method for reproducing a sound using open-ear headphones according to an embodiment of the present disclosure, the open-ear headphones (100 in FIG. 1) generate output audio signals configured with one or more channels from the source data received from a source data provision device (200 in FIG. 1) at step S801.

Here, the output audio signals may include a low-frequency audio signal and a high-frequency audio signal that are separated based on a frequency band.

Here, the output audio signals may include an audio signal corresponding to nonadjacent speakers and an audio signal corresponding to adjacent speakers, which are separated based on the type of speakers.

Also, in the method for reproducing a sound using open-ear headphones according to an embodiment of the present disclosure, the open-ear headphones (100 in FIG. 1) perform correction adapted to sound transmission pipes for the output audio signals at step S803. This is for correcting distortion in advance because some of the output sounds are distorted by being transmitted to the ear of the user via the sound transmission pipes.

Here, when the output audio signals are corrected, correction parameters may be generated using sound transmission pipe parameters.

Here, the sound transmission pipe parameters may include information corresponding to at least one of the length of each of the sound transmission pipes, the material thereof, the size thereof, and the shape thereof. This is because the pattern of change in a sound waveform varies depending on the length, material, size, and shape of the sound transmission pipe and because the time taken for a sound to be transmitted varies depending on the length of the sound transmission pipe.

Here, the correction parameters may include at least one of equalization adjustment information, delay adjustment information, and level adjustment information pertaining to the output audio signals. Accordingly, the degree by which the output sounds are distorted while passing through the sound transmission pipes may be corrected, and a problem in which the output sounds are not synchronized due to a time delay may be solved.

Also, in the method for reproducing a sound using open-ear headphones according to an embodiment of the present disclosure, the open-ear headphones (100 in FIG. 1) output the sounds from the output audio signals using speakers at step S805.

Here, the high-frequency audio signals may be output using the nonadjacent speakers, and the low-frequency audio signals may be output using the adjacent speakers.

Here, the nonadjacent speakers may include a directional sound output unit, and the adjacent speakers may be configured with bone conduction elements or exciter elements.

Also, in the method for reproducing a sound using open-ear headphones according to an embodiment of the present disclosure, the open-ear headphones (100 in FIG. 1) transmit at least some of the output sounds to the ears of the user through the sound transmission pipes such that the sounds have directivity at step S807.

Here, the sounds output from the nonadjacent speakers may be transmitted through the sound transmission pipes to the ears of the user. This is because they facilitate the output of the directional sound because high-frequency sounds have high directivity and low diffraction.

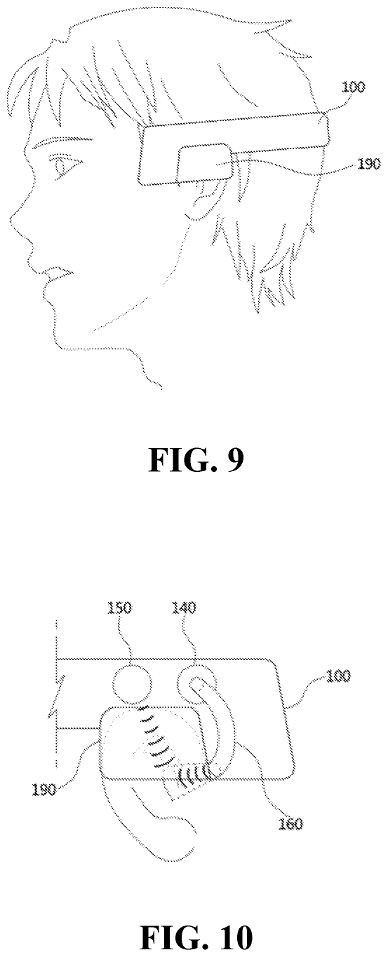

FIG. 9 is a view illustrating the appearance of wearing open-ear headphones 100 according to an embodiment of the present disclosure.

Referring to FIG. 9, the open-ear headphones 100 according to an embodiment of the present may include a sound cover 190 that concentrates output sounds towards the ear of a user while covering at least a part of the ear of the user.

Here, the sound cover 190 may cover at least a part of the ear of the user in the state in which it is spaced apart from the ear of the user.

FIG. 10 is a view illustrating an example of wearing the right-side part of open-ear headphones 100 according to an embodiment of the present disclosure.

Referring to FIG. 10, the open-ear headphones 100 concentrate output sounds on the ear of a user through a sound cover 190, which covers at least a part of the ear of the user.

The nonadjacent speaker 140 outputs the audio signal generated from source data, and the output sound is transmitted to the ear of the user through the sound transmission pipe 160. The sound transmission pipe 160 has a spiral shape, thereby increasing the directivity of the transmitted sound. Also, the nonadjacent speaker 140 may output a directional sound using a directional speaker unit.

The adjacent speaker 150 outputs the audio signal generated from the source data. Here, the adjacent speaker 150 may output the audio signal using a bone conduction element or an exciter element. Using the bone conduction element or the exciter element, directivity and attenuation problems may be solved.

The sound cover 190 concentrates the output sounds (particularly, high-frequency sounds) towards the ear of the user, thereby enabling the user to more clearly listen to the output sounds. Also, it partially blocks ambient sounds by covering a part of the ear, whereby the user may be immersed in the output sounds when listening to the output sounds.

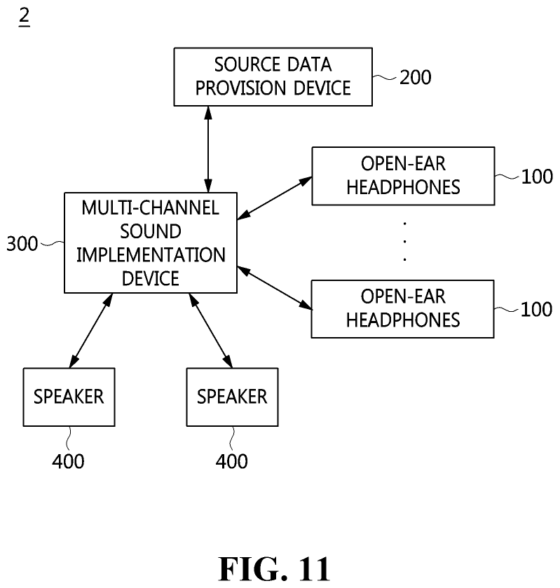

FIG. 11 is a view illustrating a multi-channel sound implementation system 2 using open-ear headphones according to an embodiment of the present disclosure.

Referring to FIG. 11, in the multi-channel sound implementation system 2 using open-ear headphones according to an embodiment of the present disclosure, a multi-channel sound implementation device 300 is interconnected with a source data provision device 200, one or more sets of open-ear headphones 100, and one or more speakers 400. Here, the multi-channel sound implementation device 300 may be connected with the open-ear headphones 100, the source data provision device 200, and the speaker 400 in a wired or wireless manner, and technology, such as Wi-Fi, Bluetooth, or the like, may be used for wireless connection.

Here, depending on the implementation, the source data provision device 200 may be implemented as a function of the multi-channel sound implementation device 300.

The multi-channel sound implementation device 300 according to an embodiment of the present disclosure receives source data from the source data provision device 200 and analyzes the source data in order to detect audio signal information of one or more channels that can be generated from the source data. Also, it analyzes information about a speaker system including the one or more speakers 400. Also, it analyzes information about the one or more sets of open-ear headphones 100, which output sounds in the state in which the ears of a user are uncovered by being spaced apart from the ears of the user. Then, using the audio signal information, the information about the speaker system, and the information about the open-ear headphones, the multi-channel sound implementation device generates speaker audio signals having one or more channels to be reproduced in the speaker system and generates headphone audio signals to be reproduced in the open-ear headphones. Then, it outputs the speaker audio signals by transmitting the same to the speaker system and outputs the headphone audio signals by transmitting the same to the respective sets of open-ear headphones corresponding thereto. The sound output from the speakers 400 and the sound output from the open-ear headphones 100 are mixed, whereby an immersive sound may be provided to the user. That is, a sound is output not only through the speakers 400 but also through the open-ear headphones 100. Because the user may hear the sound from the speakers 400 even when the user wears the open-ear headphones 100, a multi-channel sound may be implemented.

Here, the multi-channel sound implementation device 300 separates the audio channels of the source data in a matrix form and distributes the same to the speakers 400 and the open-ear headphones 100, thereby generating speaker audio signals and headphone audio signals.

Here, the multi-channel sound implementation device 300 may adjust the levels of the speaker audio signals and the headphone audio signals in an automatic manner or in a manual manner according to a configuration. When the levels are automatically adjusted, the sounds output from the speakers 400 are received using the microphone included in the open-ear headphones 100, and the levels of the speaker audio signals and the headphone audio signals may be adjusted using the received sounds.

Here, the multi-channel sound implementation device 300 may generate headphone sound signals as binaural sound signals in order to output binaural sounds through the open-ear headphones 100.

The conventional speaker system has limitations pertaining to expense and to realization of a multi-channel system because constructing the multi-channel system requires a wide area and multiple speakers. Also, a different sound is heard depending on the location in the space in which the speaker system is constructed, which distorts a 3D sound effect and decreases immersiveness. Accordingly, it is problematic in that it is impossible to listen to a perfect multi-channel sound unless located at the so-called “sweet spot,” which is the location at which the 3D effect and immersiveness are maximized. However, the multi-channel sound implementation system 2 according to an embodiment of the present disclosure realizes a multi-channel sound using the one or more speakers 400 and the one or more sets of open-ear headphones 100, whereby a sound suitable for the location of the user (or listener) may be implemented.

Here, the multi-channel sound implementation device 300 may generate speaker sound signals and headphone sound signals by distributing channels using various methods.

For example, the multi-channel sound implementation device 300 outputs sounds, the sound source of which is distant from the user, as surround sounds through the speakers 400, and outputs sounds, the sound source of which is close to the user, using the open-ear headphones 100, among the sounds included in the source data, thereby providing a better 3D effect, a sense of space, and immersiveness to the user.

Also, the multi-channel sound implementation device 300 may distribute the channels that can be output through the speakers 400, among the sounds included in the source data, to the speaker sound signals, and may distribute the other channels to the headphone sound signals. Also, the headphone sound signals may be generated as binaural sound signals.

Also, the multi-channel sound implementation device 300 may support a kind of silent mode. Here, the silent mode may be configured such that speaker audio signals are not generated or no channel is assigned to the speaker audio signals in order not to output sounds through the speakers 400 and such that all of the channels are assigned to the headphone audio signals.

Also, the multi-channel sound implementation device 300 may support a user configuration mode. Here, in the user configuration mode, a user may set information about the channels to be distributed to the speaker audio signals and the headphone audio signals. Particularly, the multi-channel sound implementation device 300 may provide a recommended configuration using the configuration information of the speakers 400, and the user may change the recommended configuration as needed, thereby setting the information about the channels to be distributed to the speaker audio signals and the headphone audio signals.

Also, when it operates in conjunction with a Virtual Reality (VR) device or a VR module, the multi-channel sound implementation device 300 may output sounds corresponding to the background objects of VR content through the speakers 400, and may output sounds corresponding to interactive objects using the open-ear headphones 100. Particularly, when the VR device is used, the sound output through the open-ear headphones 100 is corrected using the head-tracking information of a user such that the sound matches the orientation of the head of the user, whereby the accuracy of virtual space content representation may be improved.

Also, the multi-channel sound implementation device 300 may analyze the location information of the open-ear headphones 100 and head-tracking information of the user, and may correct the headphone audio signals using the analyzed information. Here, the corrected information includes at least one of level information, delay information, channel information, and equalization information.

Using the location information of the open-ear headphones 100, the delay information may be corrected in consideration of the time taken for the sounds output from the speakers 400 to reach the open-ear headphones 100.

Using the head-tracking information of the open-ear headphones 100, the direction of the sounds output from the speakers 400 may be adjusted depending on the orientations of the speakers 400. For example, when a sound source is placed in front of the user and when the user turns his or her head clockwise by 90 degrees, the direction in which the headphone audio signals are output is rotated counterclockwise by 90 degrees, whereby a sound in which the location of the sound source is correctly reflected may be output.

Also, the source data may include not only the audio channels but also a video channel. In this case, the multi-channel sound implementation device 300 may extract the audio channel and the video channel. For the audio channel, speaker audio signals and headphone audio signals are generated and corrected. For the video channel, a video signal may be corrected using the audio signals. For example, when delay information for the sounds output from the open-ear headphones 100 is set to t seconds in order to synchronize the sounds output from the speakers 400 with the sounds output from the open-ear headphones 100, delay information for the video signal may be set to t seconds.

The speaker 400 is an output device capable of outputting a sound, and may comprise multiple speakers. The respective speakers 400 may be configured with various types of channels.

Here, the speaker 400 may include a speaker embedded in an image output device, such as a TV or the like.

Here, the speaker 400 may include a speaker embedded in the multi-channel sound implementation device 300.

Here, the speaker 400 may include a subwoofer speaker, and a signal of an LFE channel may be output through the subwoofer speaker.

Here, the speaker 400 may include a sensory speaker or a vibration speaker. Here, the sensory speaker or the vibration speaker may be attached to a chair, a couch, or the like.

Here, the multiple speakers 400 may also include speakers that are not connected to form a single system. For example, even though the speakers of a 2.1-channel speaker system and a speaker embedded in a TV are not connected with each other, a multi-channel sound may be implemented by including all of these speakers.

Here, the speakers 400 may include speakers that form one or more multi-channel speaker systems. That is, the speakers may include all of the speakers included in a 2.1-channel speaker system and the speakers included in a 5.1-channel speaker system, which is separate from the 2.1-channel speaker system.

Accordingly, the user may cheaply extend the number of channels beyond that of an existing speaker system using the open-ear headphones, whereby a multi-channel sound system may be constructed. Also, using the open-ear headphones, an immersive sound having a better 3D effect, an improved sense of space, and high immersiveness may be implemented. Particularly, when multiple users use the open-ear headphones together, sounds are output in consideration of the locations of the respective users, whereby a 3D effect and immersiveness suitable for each of the multiple users may be provided.

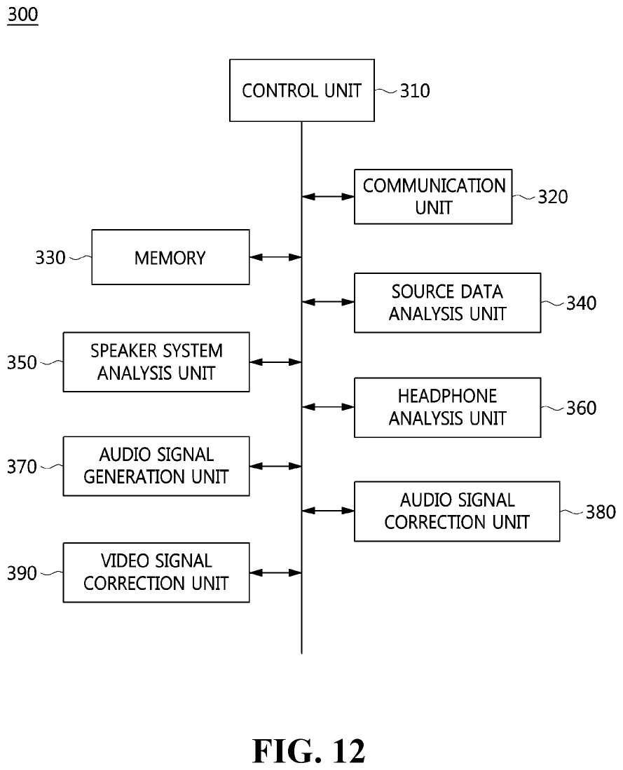

FIG. 12 is a view illustrating the multi-channel sound implementation device 300 using open-ear headphones according to an embodiment of the present disclosure, illustrated in FIG. 11.

Referring to FIG. 12, the multi-channel sound implementation device 300 using open-ear headphones according to an embodiment of the present disclosure includes a control unit 310, a communication unit 320, memory 330, a source data analysis unit 340, a speaker system analysis unit 350, a headphone analysis unit 360, an audio signal generation unit 370, an audio signal correction unit 380, a video signal correction unit 390, and the like.

Specifically, the control unit 310 is a kind of central processing unit, and controls the overall function of the multi-channel sound implementation device 300. That is, the control unit 310 may provide various functions by controlling the source data analysis unit 340, the speaker system analysis unit 350, the headphone analysis unit 360, the audio signal generation unit 370, the audio signal correction unit 380, the video signal correction unit 390, and the like.

Here, the control unit 310 may include all kinds of devices capable of processing data, such as a processor. Here, the “processor” may be, for example, a data-processing device embedded in hardware, which has a physically structured circuit in order to perform functions represented as code or instructions included in a program. Examples of the data-processing device embedded in hardware may include processing devices such as a microprocessor, a central processing unit (CPU), a processor core, a multiprocessor, an application-specific integrated circuit (ASIC), a field-programmable gate array (FPGA), and the like, but the scope of the present disclosure is not limited to these examples.

The communication unit 320 provides a communication interface that is necessary in order to send transmission/reception signals between the multi-channel sound implementation device 300, the source data provision device (200 in FIG. 11), the open-ear headphones (100 in FIG. 11), and the speaker (400 in FIG. 11).

Here, the communication unit 320 may be a device including hardware and software that are necessary in order to transmit and receive signals, such as control signals or data signals, through wired/wireless connection with other network devices. For example, the communication unit 320 may communicate with the source data provision device (200 in FIG. 11), the open-ear headphones (100 in FIG. 11), and the speaker 400 through Bluetooth technology or Wi-Fi technology, and may perform pairing with the open-ear headphones (100 in FIG. 11) through NFC technology. Also, an audio signal may be transmitted through wired connection with the speaker 400.

The memory 330 performs the function of temporarily or permanently storing the data processed by the control unit 310. Here, the memory 330 may include magnetic storage media or flash storage media, but the scope of the present disclosure is not limited thereto.

The source data analysis unit 340 analyzes the source data received from the source data provision device (200 in FIG. 11). The source data may include a sound file and an image file. Also, the source data may include one or more sound files and one or more image files.

Here, the source data analysis unit 340 may extract an audio channel from the source data, and may detect audio signal information from the audio channel. Particularly, the audio signal information may be detected using header information. Here, the header information may include channel information, object coordinate information, and the like.

Here, the audio signal information may include information about the number of channels supported by the audio channel. For example, information saying that the audio channel included in the current source data supports 2.1 channels, 5.1 channels, 7.1 channels, 11.1 channels, 22.2 channels, or the like may be identified as the channel information. The multi-channel sound implementation device 300 may set the number of channels to be used for sound output using the channel information (e.g., 22.2 channels).

Here, when the source data includes both image information and sound information, such as video, the source data analysis unit 340 may extract not only the audio channel but also a video channel from the source data.

The speaker system analysis unit 350 analyzes information about the speaker system to be used in order to implement a multi-channel sound. The speaker system includes at least one speaker (400 in FIG. 11).

Here, the speaker system analysis unit 350 may analyze the number of speakers (400 in FIG. 11) included in the speaker system, location information of the speakers, available channel information thereof, and the like as information about the speaker system. For example, information saying that the speakers support 2.1 channels may be detected. When it is possible to detect the location information of the speakers, it may be confirmed that the speaker system supporting 2.1 channels includes two main speakers and one woofer speaker that are arranged in front.

Here, the information about the speaker system may be used later when speaker audio signals to be output from the speakers (400 in FIG. 11) are generated. Particularly, using the available channel information pertaining to the speaker system, the number of channels to be assigned to the speaker audio signals may be limited. For example, when the source data supports 11.1 channels but the speaker system supports 5.1 channels, up to 5.1 channels may be assigned to the speaker audio signals.

Here, when the location information of the speakers (400 in FIG. 11) is detected as the speaker system information, a sound zone, which is the space in which the multi-channel sound system is constructed, may be determined. The size of the sound zone may be used for adjusting the time taken for an indirect sound to arrive. Also, through the size of the sound zone, the location of the open-ear headphones (100 in FIG. 11) in the sound zone may be detected, and using this, the audio signals may be corrected. Particularly, using the size of the sound zone, delay adjustment may be performed so as to match the time taken for the sound output from the speakers (400 in FIG. 11) to reach a user.

The headphone analysis unit 360 analyzes information about the open-ear headphones (100 in FIG. 11) to be used along with the speaker in order to implement a multi-channel sound. Here, the multi-channel sound implementation device is connected with one or more sets of open-ear headphones (100 in FIG. 11) and analyzes information about the headphones connected therewith.

Here, the headphone analysis unit 360 may analyze information about the specifications of the headphones, the number of sets of headphones, location information corresponding to each set of headphones, head-tracking information corresponding to each set of headphones, and the like as information about the open-ear headphones. Here, the location information may represent an abstract location (e.g., longitude and latitude), but may represent the location relative to the locations of the speakers (400 in FIG. 11) or relative to the location of the multi-channel sound implementation device 300. Also, for the head-tracking information, information such as a direction and speed related to rotation, tilting, and movement may be acquired using an acceleration sensor, a gyroscope sensor, or the like embedded in the open-ear headphones (100 in FIG. 11).

Here, the location information may be used for generating headphone audio signals that are suitable for the locations of the headphones. Also, the location information may be used for correcting the speaker audio signals and the headphone audio signals. The head-tracking information may be used in order to receive gesture input, but may also be used in order to correct the headphone audio signals depending on the orientation of the user from the aspect of sound implementation.

The audio signal generation unit 370 generates audio signals to be output using the audio signal information acquired from the source data, the information about the speaker system, and the information about the open-ear headphones.

Here, the audio signals may include the speaker audio signals having one or more channels to be reproduced in the speaker system and the headphone audio signals to be reproduced in the open-ear headphones.

Here, various methods may be used when the audio signal generation unit 370 generates speaker audio signals and headphone audio signals, as described above. For example, the channels that can be reproduced in the speaker system may be assigned to the speaker audio signals, and the other channels may be assigned to the headphone audio signals. Also, sounds, the sound source of which is a background object, may be assigned to the speaker audio signals, and the other channels may be assigned to the headphone audio signals. Also, sounds, the sound source of which is an interactive object, may be assigned to the headphone audio signals, and the other channels may be assigned to the speaker audio signals. Also, a user may generate speaker audio signals and headphone audio signals by setting channel conditions, sound source object conditions, sound source location conditions, and the like.

Here, the audio signal generation unit 370 may assign even a channel assigned to the speaker audio signals or the sound of a specific sound source to the headphone audio signals in order to enhance the output. For example, when it is necessary to emphasize a specific low-pitched sound, the corresponding low-pitched sound may be output through both the speaker and the headphones.

Here, the audio signal generation unit 370 may set the listening position of the user as a virtual listening point, and may generate speaker audio signals and headphone audio signals that match the virtual listening point. For example, when multiple users listen to a sound in a single sound zone, such as a theater, audio signals may be generated so as to output a sound that is the same as the sound that is heard when all of the users are assumed to be located in the center of the sound zone. Accordingly, when a sound is output to multiple users, sound distortion arising from variation in the positions of the respective users may be reduced, and users' satisfaction obtained from listening may be improved.

Here, the audio signal generation unit 370 may generate speaker audio signals and headphone audio signals that match the locations of the respective sets of open-ear headphones (100 in FIG. 11). For example, when multiple users experience VR or Augmented Reality (AR) in a single area, audio signals may be generated such that the sounds provided to the users match the positions of the respective users. Accordingly, when a sound is output to multiple users, a sound suitable for the positions of the respective users is output, whereby an improved sense of space, 3D effect, and immersiveness may be provided to the respective users.

When the multi-channel sound implementation device 300 includes an image output unit therein or is connected with an external image output device, information about the speaker audio signals and headphone audio signals may be output through the image output unit or device. For example, information about the channels assigned to the speaker audio signals and information about the channels assigned to the headphone audio signals may be displayed.

The audio signal correction unit 380 corrects the headphone audio signals and the speaker audio signals using at least one of the information about the speaker system and the information about the open-ear headphones.

Here, the audio signal correction unit 380 may correct the audio signals using correction parameters.

Here, the correction parameters may include level information, delay information, equalization information, channel information, output direction information, and the like. Here, the level information may be information for adjusting the levels of the speaker audio signals and the headphone audio signals in consideration of the fact that the magnitude of sounds output from the speakers (400 in FIG. 11) decreases while being transmitted to users. The delay information may be information for adjusting the delay of the speaker audio signals and the headphone audio signals in consideration of the time taken for the sounds output from the speakers (400 in FIG. 11) to be transmitted to the users. The equalization information may be information for adjusting the equalization of the speaker audio signals and the headphone audio signals in consideration of the fact that, when the sounds output from the speakers (400 in FIG. 11) are transmitted to the users, the degree of change in the sound varies depending on the frequency thereof. The channel information may be information for adjusting the channels assigned to the speaker audio signals and the headphone audio signals when it is necessary to change channels depending on the locations of the headphones. The output direction information may be information for adjusting the output direction that is set in order to implement a virtual sound source location when an immersive sound is reproduced. For example, when a user turns his or her head clockwise by 90 degrees, the output direction information may have information for correcting the direction of the headphone audio signals to rotate 90 degrees counterclockwise. That is, the audio signal correction unit 380 may correct the audio signals in consideration of the information about the locations of the headphones, head-tracking information, and the like.

Here, the audio signal correction unit 380 may correct the audio signals by automatically generating correction parameters using the collected information. Also, recommended correction parameters may be generated and provided to a user, and the audio signals may be corrected based on the recommended correction parameters to which the selection of the user is reflected or based on the modified correction parameters.

When the multi-channel sound implementation device 300 includes an image output unit therein or is connected with an external image output device, the correction parameters or correction information for the speaker audio signals and the headphone audio signals may be output through the image output device. For example, the level information pertaining to the speaker audio signals and the level information pertaining to the headphone audio signals may be displayed in the image output device.

Accordingly, distortion or disharmony, caused by configuring the devices for outputting a sound in a bimodal way using the speakers (400 in FIG. 11) and the open-ear headphones (100 in FIG. 11), may be prevented.

The video signal correction unit 390 corrects delay information pertaining to a video signal corresponding to a video channel when the video channel is included in the source data.

Here, the video signal correction unit 390 may correct the delay information pertaining to the video signal in consideration of the speaker audio signals and the headphone audio signals. For example, when the delay information for the headphone audio signals is 0 seconds and when the delay information for the speaker audio signals is t seconds, the delay for the video signal is set to t seconds, whereby the image and the sound may be synchronized with each other. If the delay information for the audio signals includes multiple pieces of delay information that are different for the respective audio signals (e.g., t1>t2>t3), the delay information for the video signal may be set to the longest delay (e.g., t1 seconds), among the pieces of delay information for the audio signals.

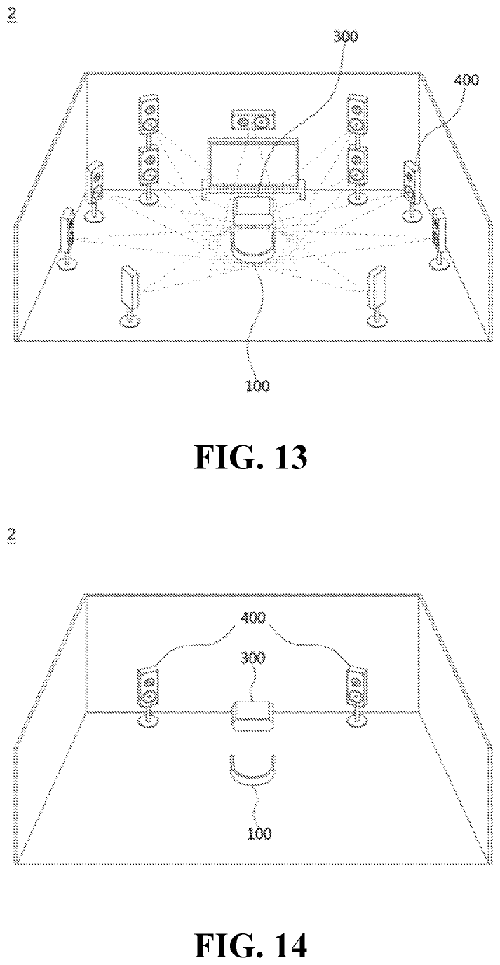

FIGS. 13 to 17 are views illustrating examples of the configuration of a multi-channel sound implementation system 2 using open-ear headphones according to an embodiment of the present disclosure.

Referring to FIG. 13, the multi-channel sound implementation system 2 using open-ear headphones according to an embodiment of the present disclosure may include a multi-channel sound implementation device 300, open-ear headphones 100, and speakers 400.

Here, the speakers 400 may form a multi-channel speaker system. Also, a speaker embedded in a TV may be included.

The open-ear headphones 100 are additionally used along with an existing speaker system, whereby a multi-channel sound having a greater number of channels may be implemented.

Referring to FIG. 14, the multi-channel sound implementation system 2 using open-ear headphones according to an embodiment of the present disclosure may include a multi-channel sound implementation device 300, open-ear headphones 100, and speakers 400.

Here, the speakers 400 include two speakers 400 placed in front in the appreciation space, thereby configuring a 2-channel speaker system.

Here, the multi-channel sound implementation device 300 may assign front sound channels to speaker audio signals and may assign the other channels to headphone audio signals. For example, when the audio channels supported by the source data are 7.1 channels, speaker audio signals are generated by assigning two channels thereto, and headphone audio signals may be generated by assigning the other channels (5.1 channels) thereto.

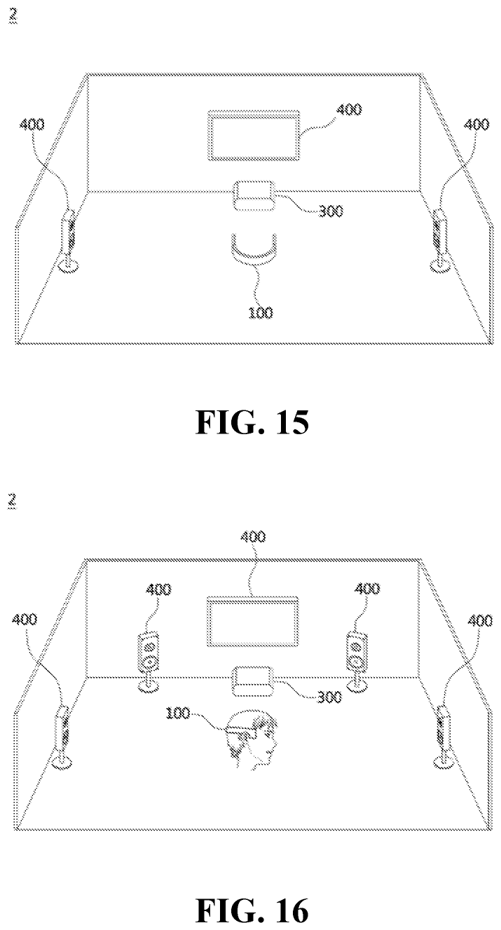

Referring to FIG. 15, the multi-channel sound implementation system 2 using open-ear headphones according to an embodiment of the present disclosure may include a multi-channel sound implementation device 300, open-ear headphones 100, and speakers 400.

Here, among the speakers 400, two speakers are placed at opposite sides of the appreciation space so as to output surround sounds, and the speaker included in a TV located in front in the appreciation space may output a front sound.

Here, the multi-channel sound implementation device 300 may assign front sound channels to the speaker audio signals corresponding to the TV, assign surround sound channels to the speaker audio signals corresponding to the side surround speakers, and assign the other channels to headphone audio signals.

Referring to FIG. 16, the multi-channel sound implementation system 2 using open-ear headphones according to an embodiment of the present disclosure may include a multi-channel sound implementation device 300, open-ear headphones 100, and speakers 400.

Here, among the speakers 400, two speakers that are spatially separate in front in the appreciation space may output front-left and front-right sounds, two speakers placed at the opposite sides of the appreciation space may output surround sounds, and the speaker included in the TV placed in front in the appreciation space may output a center-front sound.

Here, the multi-channel sound implementation device 300 may assign center-front sound channels to the speaker audio signals corresponding to the TV, assign front-left and front-right sound channels to the speaker audio signals corresponding to the front speakers, assign surround sound channels to the audio signals corresponding to the side surround speakers, and assign the other channels to headphone audio signals.

Here, the multi-channel sound implementation device 300 may detect information about the movement of the open-ear headphones 100 using head-tracking information of the open-ear headphones 100, and may correct the headphone audio signals based thereon. For example, when a user wearing the open-ear headphones 100 turns his or her head to the right side (clockwise) by 90 degrees, as illustrated in FIG. 16, the direction in which the headphone audio signals are to be output may be made to rotate 90 degrees to the left side (counterclockwise).

Accordingly, even though the user moves or turns his or her head, the location of a sound source or an object formed by binaural encoding may be maintained without change.

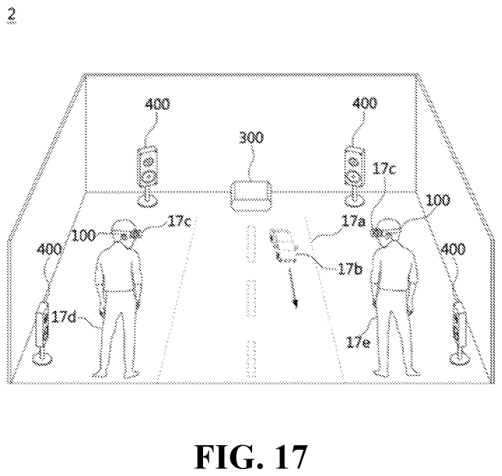

Referring to FIG. 17, the multi-channel sound implementation system 2 using open-ear headphones according to an embodiment of the present disclosure may include a multi-channel sound implementation device 300, open-ear headphones 100, and speakers 400.

Here, among the speakers 400, two speakers that are spatially separate in front in the appreciation space may output front-left and front-right sounds, and two speakers placed at the opposite sides of the appreciation space may output surround sounds. Users 17d and 17e may use a VR/AR device or a head-mount display 17c along with the open-ear headphones 100. Here, the VR/AR device 17c may be a module mountable on the open-ear headphones 100, but may be a device separate from the headphones. In this case, source data may be the VR/AR content provided from the VR/AR device 17c.

The road 17a and the vehicle 17b marked with dotted lines in FIG. 17 are the content that the users 17d and 17e view through the VR/AR device 17c. The road 17a included in the content goes between the two users 17d and 17e, and the vehicle 17b is moving downward along the road 17a.

Here, the multi-channel sound implementation device 300 may generate background sounds as speaker audio signals for output from the speakers 400, and may generate object sounds as headphone audio signals for output from the open-ear headphones 100. For example, the sound of the vehicle 17b may be generated as the headphone audio signals, and the other sounds may be generated as the speaker audio signals.

Here, the multi-channel sound implementation device 300 may generate headphone audio signals that match the locations of the respective sets of headphones using information about the locations of the respective sets of headphones. That is, when an object is assumed to be present inside a sound zone, the sound audible at the location of a user may be generated as headphone audio signals. For example, because the vehicle 17b is located on the right side of the user 17d, headphone audio signals may be generated such that the vehicle sound is heard from the right side in the open-ear headphones 100 of the user 17d. Also, because the vehicle 17b is located on the left side of the user 17e, headphone audio signals may be generated such that the vehicle sound is heard from the left side in the open-ear headphones 100 of the user 17e.

Accordingly, a 3D effect, a sense of space, and immersiveness in the sound provided to the user may be maximized, and a realistic sound may be provided to all of multiple users. These effects may be improved when interactive content is provided, as in the above example.

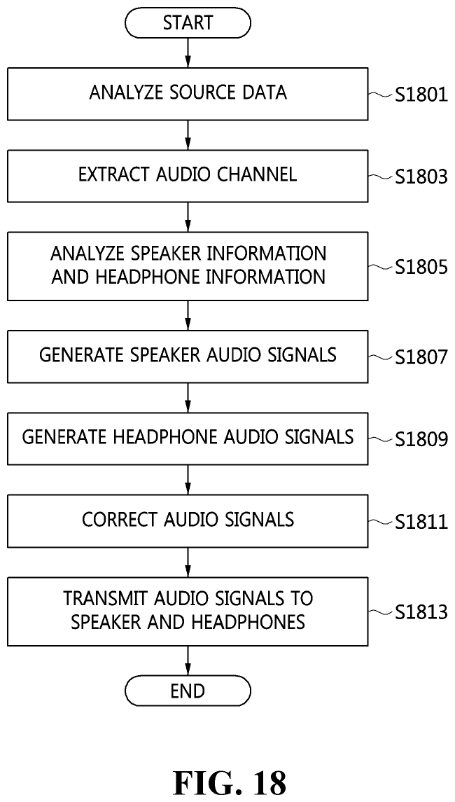

FIG. 18 is a flowchart illustrating a method for implementing a multi-channel sound using open-ear headphones according to an embodiment of the present disclosure.

Referring to FIG. 18, in the method for implementing a multi-channel sound using open-ear headphones according to an embodiment of the present disclosure, a multi-channel sound implementation device (300 in FIG. 11) analyzes the source data received from a source data provision device (200 in FIG. 11) at step S1801.

Here, the source data is analyzed, whereby channel information, object location information, and the like pertaining to the audio signal included in the source data may be identified.

Also, in the method for implementing a multi-channel sound using open-ear headphones according to an embodiment of the present disclosure, the multi-channel sound implementation device (300 in FIG. 11) extracts an audio channel from the source data at step S1803.

Here, when image data is included in the source data, not only the audio channel but also a video channel may be extracted.

Also, in the method for implementing a multi-channel sound using open-ear headphones according to an embodiment of the present disclosure, the multi-channel sound implementation device (300 in FIG. 11) analyzes information about the speaker system, through which a sound is to be output, and information about the open-ear headphones, through which a sound is to be output, at step S1805.

Here, the information about the speaker system may include the number of speakers, channel information pertaining to the speakers, location information pertaining to the speakers, and the like, and the information about the headphones may include information about the specifications of the headphones, channel information pertaining to the headphones, information about the number of sets of headphones, location information pertaining to the headphones, and the like.

Also, in the method for implementing a multi-channel sound using open-ear headphones according to an embodiment of the present disclosure, the multi-channel sound implementation device (300 in FIG. 11) may generate speaker audio signals using the audio signal information, the information about the speaker system, and the information about the headphones at step S1807.

Also, in the method for implementing a multi-channel sound using open-ear headphones according to an embodiment of the present disclosure, the multi-channel sound implementation device (300 in FIG. 11) may generate headphone audio signals using at least one of the audio signal information, the information about the speaker system, and the information about the headphones at step S1809.

Also, in the method for implementing a multi-channel sound using open-ear headphones according to an embodiment of the present disclosure, the multi-channel sound implementation device (300 in FIG. 11) corrects the speaker audio signals and the headphone audio signals using at least one of the information about the speaker system and the information about the headphones at step S1811.

Here, correction parameters may be used in order to correct the audio signals. The correction parameters may include level information, delay information, equalization information, channel information, output direction information, and the like.

Here, when image data is included in the source data, a video signal corresponding to the image data may be corrected using the correction parameters of the audio signals.

Also, in the method for implementing a multi-channel sound using open-ear headphones according to an embodiment of the present disclosure, the multi-channel sound implementation device (300 in FIG. 11) transmits the speaker audio signals to the speakers and transmits the headphone audio signals to the open-ear headphones at step S1813.

Accordingly, the sounds output from the speakers and the headphones are mixed, whereby sounds having an improved sense of space, 3D effect, and immersiveness may be provided.

In an alternative embodiment, among the above steps S1801, S1803, S1805, S1807, S1809, S1811 and S1813, generating the speaker audio signals at step S1807 and generating the headphone audio signals at step S1809 may be performed.

In an alternative embodiment, among the above steps S1801, S1803, S1805, S1807, S1809, S1811 and S1813, generating the headphone audio signals at step S1809 may be performed before generating the speaker audio signals at step S1807.

Although specific embodiments have been described in the specification, they are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential,” “important,” or the like, are used, corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. A device for implementing a multi-channel sound, comprising:
a source data analysis unit for analyzing source data in order to detect audio signal information of one or more channels generatable from the source data;
a speaker system analysis unit for analyzing information about a speaker system;
a headphone information analysis unit for analyzing information about one or more sets of open-ear headphones that output sounds in a state in which ears of a user are uncovered by being spaced apart from the ears of the user;
an audio signal generation unit for generating speaker audio signals having one or more channels to be reproduced in the speaker system and headphone audio signals to be reproduced in the one or more sets of open-ear headphones using the audio signal information, the information about the speaker system, and the information about the one or more sets of open-ear headphones; and
a communication unit for transmitting the speaker audio signals to the speaker system and transmitting the headphone audio signals to respective sets of the one or more sets of open-ear headphones corresponding thereto.

2. The device of claim 1, wherein the information about the speaker system includes at least one of a number of speakers included in the speaker system, location information pertaining to the at least one of a number of speakers, and available channel information pertaining to the at least one of a number of speakers.

3. The device of claim 2, wherein:
the information about the one or more sets of open-ear headphones includes a number of sets of open-ear headphones and headphone location information corresponding to each of the one or more sets of open-ear headphones, and
the audio signal generation unit generates the headphone audio signals corresponding to the headphone location information.

4. The device of claim 3, further comprising:
an audio signal correction unit for correcting the headphone audio signals and the speaker audio signals using the headphone location information.

5. The device of claim 4, wherein the audio signal correction unit corrects at least one of level information, delay information, channel information, equalization information, and output direction information for each of the headphone audio signals and the speaker audio signals.

6. The device of claim 5, wherein:
the information about the one or more sets of open-ear headphones includes head-tracking information corresponding to each of the one or more sets of open-ear headphones, and
the audio signal correction unit corrects the headphone audio signals depending on an orientation of each of the one or more sets of open-ear headphones using the head-tracking information.

7. The device of claim 6, further comprising:
a video signal correction unit for correcting delay information of a video signal corresponding to a video channel in consideration of the headphone audio signals and the speaker audio signals when the video channel is included in the source data.

8. The device of claim 7, wherein the audio signal correction unit corrects the headphone audio signals and the speaker audio signals using the headphone location information so as to provide a stereophonic sound obtainable when the one or more sets of open-ear headphones are located at a preset virtual point.

9. The device of claim 8, wherein the audio signal correction unit corrects the headphone audio signals and the speaker audio signals using the headphone location information so as to provide a stereophonic sound corresponding to a location of each of the one or more sets of open-ear headphones.

10. The device of claim 9, wherein, when operation of the one or more sets of open-ear headphones is stopped, the audio signal generation unit again generates the speaker audio signals for outputting sounds only through the speaker system.

11. A method for implementing a multi-channel sound, comprising:
analyzing source data in order to detect audio signal information of one or more channels generatable from the source data;
analyzing information about a speaker system;
analyzing information about one or more sets of open-ear headphones that output sounds in a state in which ears of a user are uncovered by being spaced apart from the ears of the user;
generating speaker audio signals having one or more channels to be reproduced in the speaker system and headphone audio signals to be reproduced in the one or more sets of open-ear headphones using the audio signal information, the information about the speaker system, and the information about the one or more sets of open-ear headphones; and
transmitting the speaker audio signals to the speaker system and transmitting the headphone audio signals to respective sets of the one or more sets of open-ear headphones corresponding thereto.

12. The method of claim 11, wherein the information about the speaker system includes at least one of a number of speakers included in the speaker system, location information pertaining to the at least one of a number of speakers, and available channel information pertaining to the at least one of a number of speakers.

13. The method of claim 12, wherein:
the information about the one or more sets of open-ear headphones includes a number of sets of open-ear headphones and headphone location information corresponding to each of the one or more sets of open-ear headphones, and
generating the speaker audio signals and the headphone audio signals comprises generating the headphone audio signals corresponding to the headphone location information.

14. The method of claim 13, further comprising:
an audio signal correction unit for correcting the headphone audio signals and the speaker audio signals using the headphone location information.

15. The method of claim 14, wherein correcting the headphone audio signals and the speaker audio signals comprises correcting at least one of level information, delay information, channel information, equalization information, and output direction information for each of the headphone audio signals and the speaker audio signals.

16. The method of claim 15, wherein:
the information about the one or more sets of open-ear headphones includes head-tracking information corresponding to each of the one or more sets of open-ear headphones, and
correcting the headphone audio signals and the speaker audio signals comprises correcting the headphone audio signals depending on an orientation of each of the one or more sets of open-ear headphones using the head-tracking information.

17. The method of claim 16, further comprising:
correcting delay information of a video signal corresponding to a video channel in consideration of the headphone audio signals and the speaker audio signals when the video channel is included in the source data.

18. The method of claim 17, wherein correcting the headphone audio signals and the speaker audio signals comprises correcting the headphone audio signals and the speaker audio signals using the headphone location information so as to provide a stereophonic sound obtainable when the one or more sets of open-ear headphones are located at a preset virtual point.

19. The method of claim 18, wherein correcting the headphone audio signals and the speaker audio signals comprises the headphone audio signals and the speaker audio signals using the headphone location information so as to provide a stereophonic sound corresponding to a location of each of the one or more sets of open-ear headphones.

20. The method of claim 19, wherein generating the headphone audio signals and the speaker audio signals comprises again generating the speaker audio signals for outputting sounds only through the speaker system when operation of the one or more sets of open-ear headphones is stopped.
